(19) United States
(12) Patent Application Publication
(10) Pub. No.: US 2019/0340301 A1
(43) Pub. Date: Nov. 7, 2019

(54) ATHLETE SKILL TRACKING SYSTEM

(71) Applicant: Sandra Mosak, Wauconda, IL (US)

(72) Inventor: Sandra Mosak, Wauconda, IL (US)

(21) Appl. No.: 15/969,741

(22) Filed: May 2, 2018

(51) Int. Cl. G06F 17/30; A63B 24/00; G06K 7/14

(52) U.S. Cl. CPC G06F 17/30879; G06K 7/1413; A63B 24/0062

(57) ABSTRACT

A system for tracking performance of a user; the system for tracking performance of a user includes a server, a barcode-device, a barcode-scanning means, a software-application and a communication-network. The system for tracking performance of a user is useful for providing a means for tracking performance of at least one athlete.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of sports tracking systems and more specifically relates to a system for tracking skill development of athletes.

### 2. Description of Related Art

Conventional athletic training methods and techniques may include weight lifting, jump training, sprint training, agility training, and the like. Each training regimen often requires extensive training supervision by a coach or trainer. As such, much of the efficiency and individualistic training focus is lost or even avoided. Limited personnel, unskilled personnel, and cost and time restraints make effective off-season training ineffective. Training regimens are generally segregated and conducted without looking at the effects to, or an integration with, other training regimens.

Further, without the proper implementation and timing for the individual training tasks, athletes are often unable to properly focus the workouts in a manner that serves to maximize the individual's needs against the goals of the specific regimen (i.e., timing, strength, jumping, etc.) or the aggregate regimen schedule. Currently, when athletes are being evaluated, coaches are taking handwritten notes on cards regarding the athlete's times and scores. These cards can become lost, jersey numbers can be mixed up, and handwriting can be undecipherable. At the end of an event, scores need to be added up, input into a spreadsheet, and sent out to colleges. Thus, a suitable solution is desired.

U.S. Pat. No. 7,914,419 to Chris Demetrios relates to a physical activity manager. The described physical activity manager includes a system that facilitates activity management and tracking with respect to an individual. The innovation employs the notion of establishing a strategy to compress activity information into an identifying indicia (e.g., two-dimensional barcode) that can be processed (e.g., scanned) by a wide array of devices (e.g., mobile phone, personal data assistant). The innovation discloses a system that facilitates the ability to plan, monitor and log activity of an individual. The planning phase enables a user or third party (e.g., health-care professional) to proactively define an exercise or activity regimen for a user. The monitoring phase enables real-time fitness and/or activity tracking of an individual. Finally, the logging phase enables a user to log the information into a fitness log that can be subsequently used in health or fitness-related assessment.

### BRIEF SUMMARY OF THE INVENTION

In view of the foregoing disadvantages inherent in the known sports tracking systems art, the present disclosure provides a novel athlete skill tracking system. The general purpose of the present disclosure, which will be described subsequently in greater detail, is to provide a system for effectively tracking skill development of athletes.

A system is disclosed herein. The system includes a server which may include a server-processor and a server-memory. The server-memory may include a server-database including a plurality of user-records, and each of the user-records including a plurality of user information-files. Further included may be a barcode-device configured to be worn on a body-part of the user and include identification-indicia specific to the user. A barcode-scanning means may be provided and configured to scan the identification-indicia on the barcode-device. In addition to this, a software-application may be provided and downloadable to an electronic-device, and a communication-network may communicably couple the server, the barcode-scanning means and the electronic-device.

A method of using the system is also disclosed herein. The method of using system may comprise the steps of: a providing the system as above; downloading the software-application to the electronic-device; creating at least one user-profile and a coach-profile on the software-application; scanning the identification-indicia on the barcode-device with the barcode-scanning means; viewing an associated user-record from the plurality of user-records; and recording performance-information on the software-application; wherein the system for tracking performance of a user provides means for tracking performance of at least one athlete.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an athlete skill tracking system, constructed and operative according to the teachings of the present disclosure.

FIG. 1 is a front perspective view of the system during an ‘in-use’ condition, according to an embodiment of the disclosure.

FIG. 2 is a front perspective view of the system of FIG. 1, according to an embodiment of the present disclosure.

FIG. 3 is a front perspective view of the system of FIG. 1, according to an embodiment of the present disclosure.

FIG. 4 is a front perspective view of the system of FIG. 1, according to an embodiment of the present disclosure.

FIG. 5 is a front perspective view of the system of FIG. 1, according to an embodiment of the present disclosure.

FIG. 6 is a front perspective view of the system of FIG. 1, according to an embodiment of the present disclosure.

FIG. 7 is a front perspective view of the system of FIG. 1, according to an embodiment of the present disclosure.

FIG. 8 is a flow diagram illustrating a method of use for the system, according to an embodiment of the present disclosure.

FIG. 9 is a flow diagram illustrating a method of use for the system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to sports tracking systems and more particularly to an athlete skill tracking system as used to improve the means for tracking skill development of athletes.

Generally disclosed is a method (means) to automatically track skill progress for any sport or fitness activity to assist coaches in evaluating athletes. Provided may be a system that includes a mobile application, computer software, a bar code bracelet, and a handheld scanner. For example, this may enable coaches to automatically capture timed skills, such as the 20-yard shuttle, while also allowing users to manually enter measured skills, such as vertical jumps.

It may afford athletes the ability to track their own development and assists coaches in their recruitment and scouting efforts. Further, the system may provide an accurate timing device and eliminate the need to decipher handwritten notes. The present invention allows coaches and athletes to send an individual's stats to a college quickly and in real time. In addition, the system may provide scores automatically at the end of an event. To use the system, the bar code bracelet worn by the athletes may be scanned and attached to the record of that individual athlete that is downloaded into a cloud-based database based on barcodes and ID numbers.

Manual information for an athlete may also be entered if needed. The coaches on the field may use the mobile application on their phone or the self-scanner. The software/app may include a stopwatch that may allow for accurate timing of timed skills once the athlete's bracelet is scanned and their identity is confirmed. Measured skills may be entered manually into the database using the app or desktop software. The database may be accessed by coaches who log in and view the athlete and their progress. All of the data from the app and scanner may be uploaded into the athlete's record automatically and instantly. The exact specifications may vary.

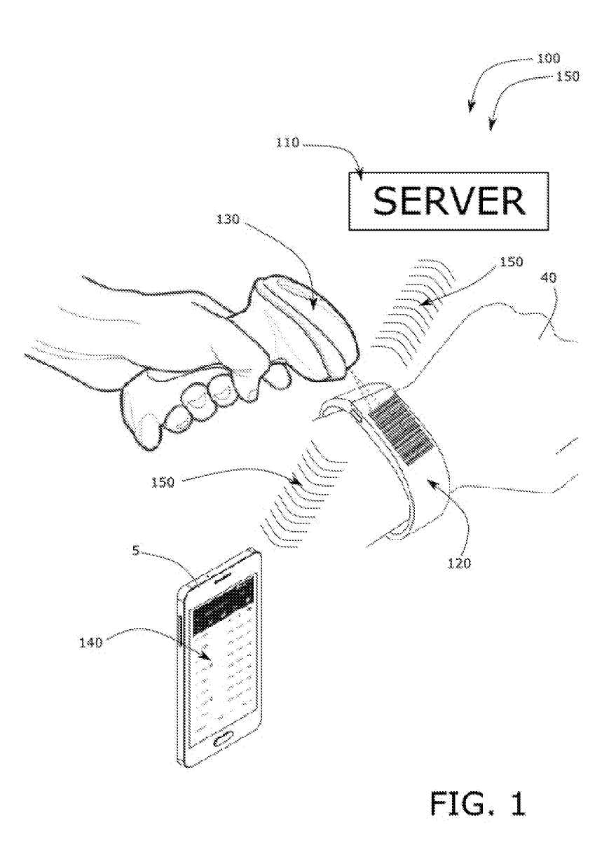

Referring now more specifically to the drawings by numerals of reference, there is shown in FIGS. 1-6, various views of a system 100.

FIG. 1 shows a system 100 during an ‘in-use’ condition 150, according to an embodiment of the present disclosure. The system 100 may be used for tracking performance of a user 40. Further, the system 100 may provide means for tracking performance of an athlete. As Illustrated, the system 100 may include a server 110, a barcode-device 120, a barcode-scanning means 130, a software-application 140 and a communication-network 150. The communication-network 150 may communicably couple the server, the barcode-scanning means 130 and an electronic-device 5.

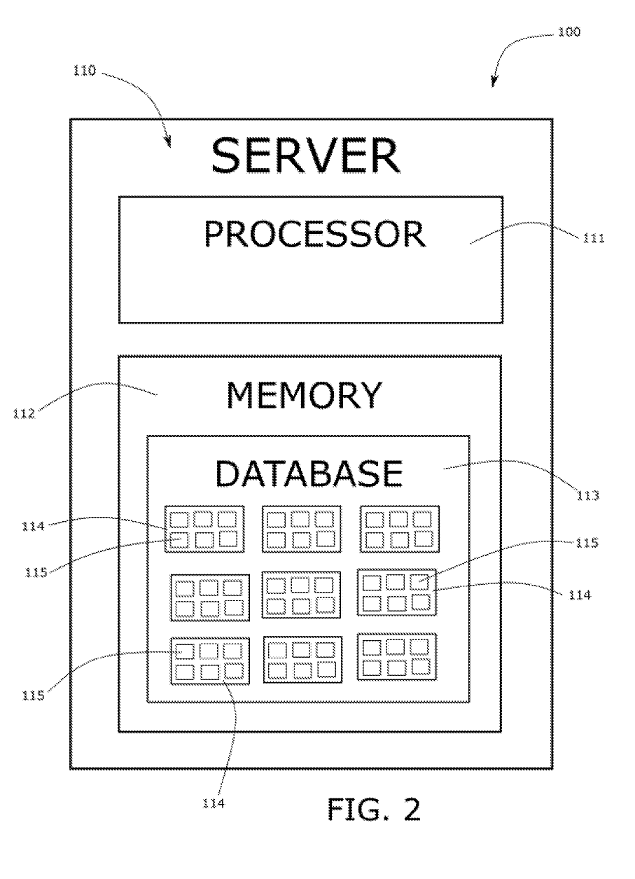

Referring now to FIG. 2 showing the system 100 according to an embodiment of the present disclosure. As shown, the server 110 may include a server-processor 111 and a server-memory 112. The server-memory 112 may include a server-database 113 including a plurality of user-records 114, and each of the user-records 114 including a plurality of user information-files 115.

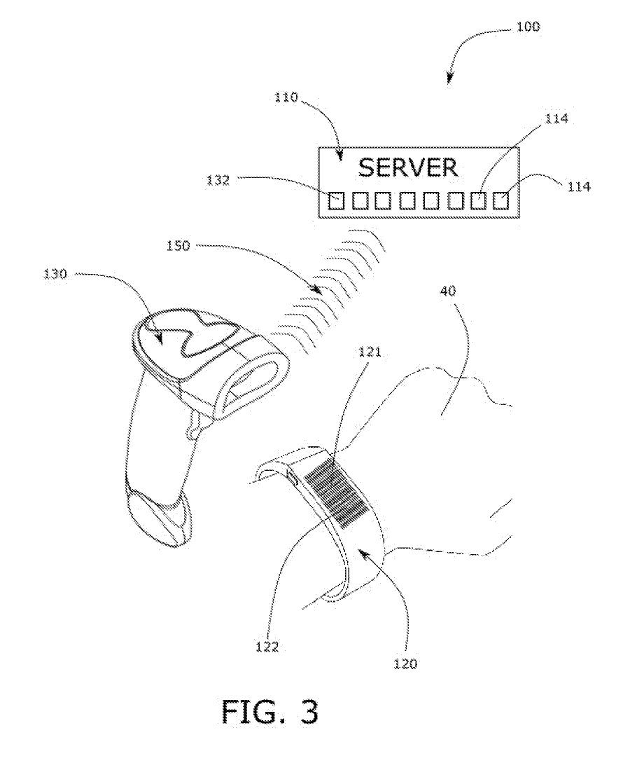

FIG. 3 shows a front perspective view of the system 100 of FIG. 1, according to an embodiment of the present disclosure. As shown, the barcode-device 120 may configured to be worn on a body-part of the user. In a preferred embodiment, the barcode-device 120 may be a bracelet configured to be worn on a wrist of the user 40. In other embodiments, the barcode-device 120 may be an anklet configured to be worn on an ankle of the user 40. Further, the barcode-device 120 may include identification-indicia 121 specific to the user 40. In a preferred embodiment, the identification-indicia 121 may be an optical representation of data 122 specific to the user, and the optical representation of data 122 specific to the user may be associated with at least one of the plurality of user-records 114. The optical representation may be a one-dimensional barcode including varying widths and spacings of parallel lines or a two-dimensional barcode including rectangles, dots, hexagons and other geometric patterns.

The barcode-scanning means 130 may be configured to scan the identification-indicia 121 on the barcode-device 120. In the preferred embodiment, the barcode-scanning means 130 may include a means to translate the optical representation of data 122 into electrical-data 132. The means may be a light-source, a lens, and a light-sensor. Further, the barcode-scanning means 130 may include decoder circuity configured to analyze image data provided by the sensor upon scanning of the optical representation of data 122. The barcode-scanning means 130 may then be configured to send the electrical-data 132 to the server via the communication-network 150.

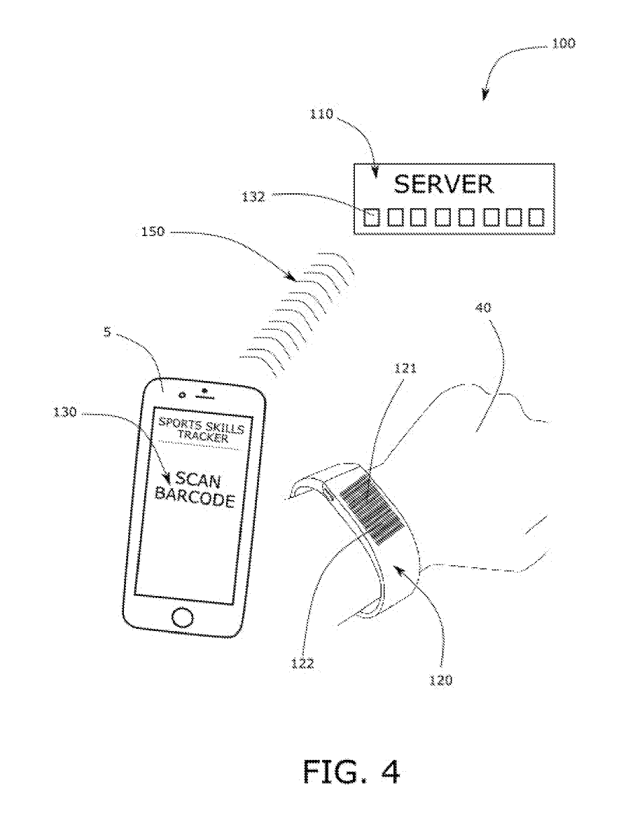

FIG. 4 shows a front perspective view of the system 100 of FIG. 1, according to an embodiment of the present disclosure. As shown, in one embodiment, the barcode-scanning means 130 may be integral to the electronic-device 5. In this embodiment, the optical representation of data 122 may be a QR code barcode. In use, the user 40 may utilize a camera on their electronic-device 5 to scan the barcode, analyze the image data, and send the electrical-data 132 to the server 110 via the communication-network 150, as above.

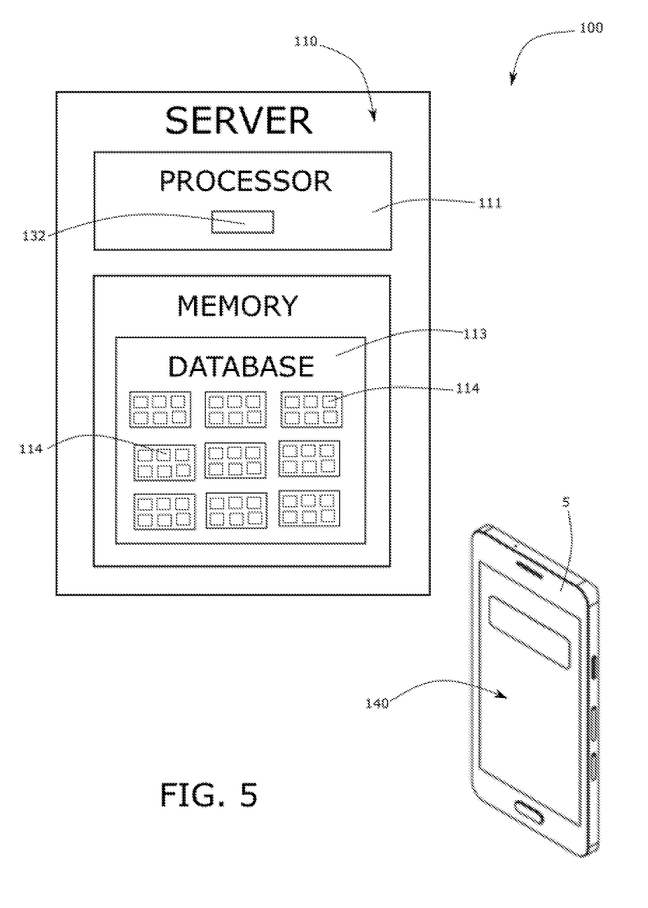

Referring now to FIG. 5 showing a diagram of the system 100 of FIG. 1, according to an embodiment of the present disclosure. As shown in this figure, the server-processor 111 may be configured to read the electrical-data 132 and retrieve an associated user-record from the plurality of user-records 114 in the server-database 113. Further, the server-processor 111 may then send the associated user-record to the software-application 140 for viewing on a display-screen of the electronic-device 5.

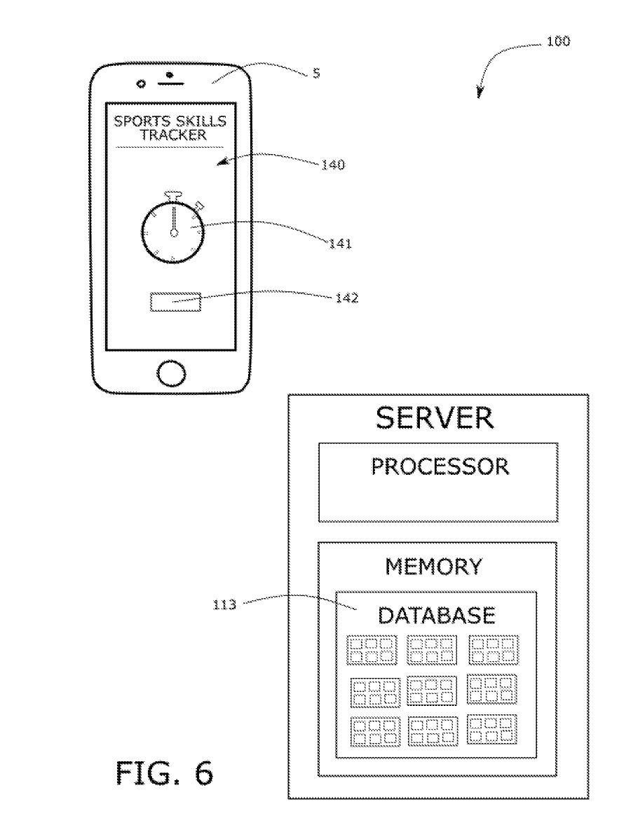

FIG. 6 shows a front perspective of the system 100 of FIG. 1, according to an embodiment of the present disclosure. Illustrated here is the software-application 140. The software-application 140 may be downloadable to the electronic-device 5. In the preferred embodiment, the software-application 140 may include performance-tracking means 141 specific to the user. In one example, the at least one of the performance-tracking means 141 may include a stopwatch. For example, the user may utilize the stopwatch to time a runtime.

The at least one of the performance-tracking means 141 may be configured to generate performance-information 142 as a tangible result. Further, the software-application 140 may include means to manually enter performance-information 142 via a user-interface on the electronic-device 5. For example, the user may manually enter the runtime, statistics, etc. The software-application 140 may then be configured to send the performance-information 142 to the server 110 (or cloud) for storage in the associated user-record on the server-database 113. In this embodiment, the plurality of user information-files 115 may include the performance-information 142.

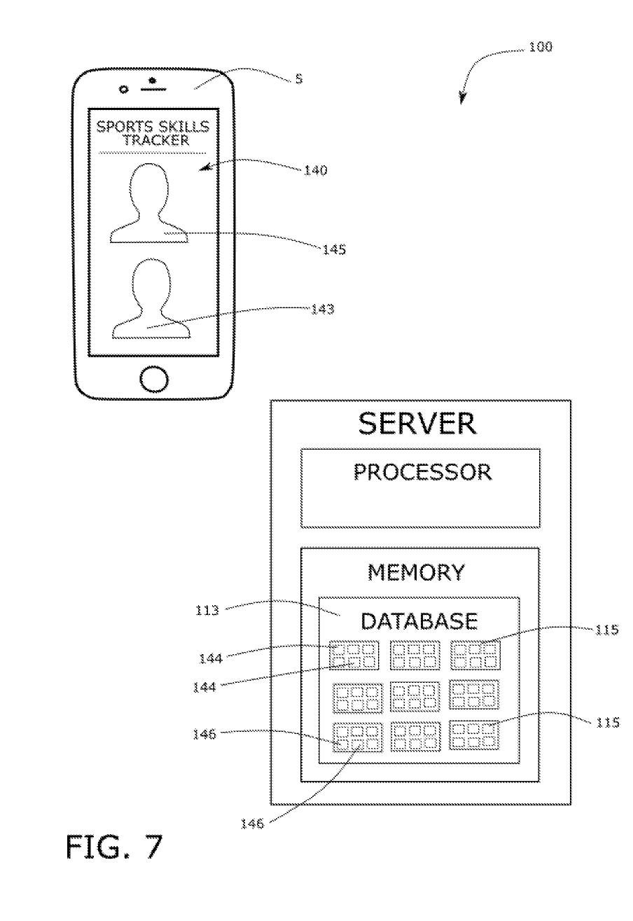

Referring now to FIG. 7 showing a diagram of the system 100 of FIG. 1, according to an embodiment of the present disclosure. Illustrated here is user-profiles of the software-application 140. The software-application 140 may include a coach-profile 143 and a user-profile 145 and the server-database 113 may include coach-specific information 144 and user-specific information 146. The coach-specific information 144 may include statistics of their teams, and at least one of the plurality of user information-files 115 pertaining to an athlete they coach. The user-specific information 146 may include the user information-file that is specific to that particular user-profile 145, such that other users may not be able to view other users.

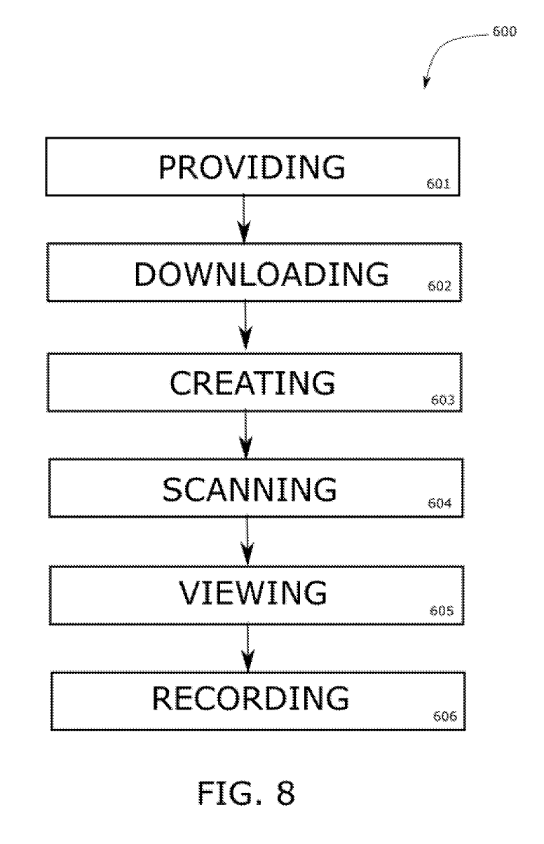

FIG. 8 is a flow diagram illustrating a method of using a system for tracking performance of a user 600, according to an embodiment of the present disclosure. As illustrated, the method of using a system for tracking performance of a user 600 may include the steps of: step one 601, a providing the system 100 as above; step two 602; downloading the software-application 140 to the electronic-device 5; step 603, creating at least one of a user-profile 145 and a coach-profile 143 on the software-application 140; step four 604, scanning the identification-indicia 121 on the barcode-device 120 with the barcode-scanning means 130; step five 605, viewing an associated user-record from the plurality of user-records 114; and step six 606, recording performance-information 142 on the software-application 140.

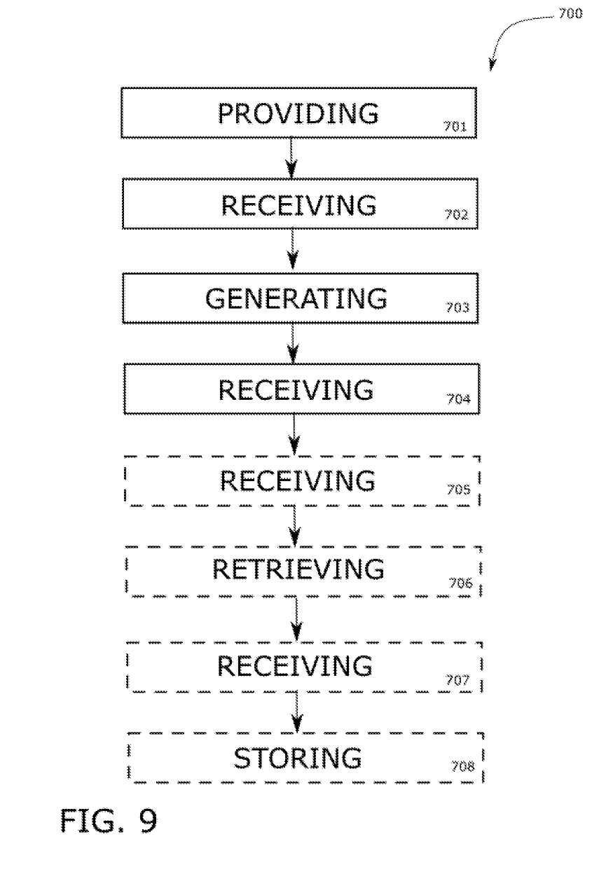

FIG. 9 is a flow diagram illustrating a method of tracking performance of a user 700, according to an embodiment of the present disclosure. As illustrated, the method of tracking performance of a user 700 may include the steps of: step one 701, providing the system 100 as above; step two 702, receiving at least one of a user-information and a coach-profile 143 at the server; step three 703, generating at least one of a user-profile 145 and a coach-profile 143 based on the at least one of the user-information and the coach-profile 143 via the server-processor 111; and step four 704, receiving electronic-data at the server-processor 111 and generating an associated user-record. Further steps may include: step five 705, receiving the electronic-data 132 at the server-processor 111; step six 706, retrieving the associated user-record 114 and sending the associated user-record 114 to the software-application 140; step seven 707, receiving performance-information 142 at the server via the software-application 140; and step eight 708, storing the performance-information 142 within the associated user-record on the server-database 113.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for tracking performance of a user, the system comprising:
a server including a server-processor and a server-memory, the server-memory including a server-database, the server-database including a plurality of user-records, and wherein each of the user-records includes a plurality of user information-files;
a barcode-device configured to be worn on a body-part of the user, the barcode-device including identification-indicia specific to the user;
a barcode-scanning means configured to scan the identification-indicia on the barcode-device;
a software-application downloadable to an electronic-device;
a communication-network communicably coupling the server, the barcode-scanning means and the electronic-device; and
wherein the system for tracking performance of a user provides means for tracking performance of an athlete.

2. The system of claim 1, wherein the barcode-device is a bracelet configured to be worn on a wrist of the user.

3. The system of claim 1, wherein the identification-indicia is an optical representation of data specific to the user.

4. The system of claim 3, wherein the optical representation of data specific to the user is associated with at least one of the plurality of user-records.

5. The system of claim 4, wherein the barcode-scanning means includes a means to translate the optical representation of data into electrical-data.

6. The system of claim 5, wherein the means to translate the optical representation of data into electrical-data is a light-source, a lens, and a light-sensor.

7. The system of claim 6, wherein the barcode-scanning means is further configured to send the electrical-data to the server via the communication-network.

8. The system of claim 7, wherein the server-processor is configured to read the electric-data and retrieve an associated user-record from the plurality of user-records in the server-database.

9. The system of claim 8, wherein the server-processor is further configured to send the associated user-record to the software-application for viewing on a display-screen of the electronic-device.

10. The system of claim 1, wherein the software-application includes performance-tracking means specific to said user.

11. The system of claim 10, wherein the at least one of the performance-tracking means includes a stopwatch.

12. The system of claim 10, wherein the at least one of the performance-tracking means is configured to generate performance-information as a tangible result.

13. The system of claim 11, wherein the software-application includes means to manually enter performance-information via a user-interface on the electronic-device.

14. The system of claim 12, wherein the software-application is configured to send the performance-information to the server for storage in the associated user-record on the server-database.

15. The system of claim 14, wherein the plurality of user information-files includes the performance-information.

16. The system of claim 1, wherein the software-application further includes a coach-profile and a user-profile; and
wherein the server-database includes coach-specific information and user-specific information.

17. The system of claim 1, wherein the barcode-scanning means is integral to the electronic-device.

18. A method of using a system for tracking performance of a user, the method comprising the steps of:
providing the system for tracking performance of the user, the system including:
a server including a server-processor and a server-memory, the server-memory including a server-database, the server-database including a plurality of user-records, and wherein each of the user-records includes a plurality of user information-files;
a barcode-device configured to be worn on a body-part of the user, the barcode-device including identification-indicia specific to the user;
a barcode-scanning means configured to scan the identification-indicia on the barcode-device;
a software-application downloadable to an electronic-device; and
a communication-network communicably coupling the server, the barcode-scanning means and the electronic-device; and
downloading the software-application to the electronic-device;
creating at least one of a user-profile and a coach-profile on the software-application;
scanning the identification-indicia on the barcode-device with the barcode-scanning means;
viewing an associated user-record from the plurality of user-records; and
recording performance-information on the software-application; and
wherein the system for tracking performance of a user provides means for tracking performance of at least one athlete.

19. A method of tracking performance of a user, the method comprising the steps of:
providing a system for tracking performance of the user, the system including:
a server including a server-processor and a server-memory, the server-memory including a server-database, the server-database including a plurality of user-records, and wherein each of the user-records includes a plurality of user information-files;
a barcode-device configured to be worn on a body-part of the user, the barcode-device including identification-indicia specific to the user;
a barcode-scanning means configured to scan the identification-indicia on the barcode-device;
a software-application downloadable to an electronic-device; and
a communication-network communicably coupling the server, the barcode-scanning means and the electronic-device;
receiving at least one of a user-information and a coach-profile at the server;
generating at least one of a user-profile and a coach-profile based on the at least one of the user-information and the coach-profile via the server-processor; and
receiving electronic-data at the server-processor and generating an associated user-record.

20. The method of claim 19, further including the steps of:
receiving the electronic-data at the server-processor;
retrieving the associated user-record and sending the associated user-record to the software-application;
receiving performance-information at the server via the software-application; and
storing the performance-information within the associated user-record on the server-database.
